(19) United States
(12) Patent Application Publication
(10) Pub. No.: US 2025/0183549 A1
(43) Pub. Date: Jun. 5, 2025

(54) ANTENNA AND COMMUNICATION DEVICE

(71) Applicant: HUAWEI TECHNOLOGIES CO., LTD., Shenzhen (CN)

(72) Inventors: Yudong Zhang, Xi’an (CN); Bin Liang, Xi’an (CN); Hang Zhou, Xi’an (CN); Jie Peng, Shanghai (CN); WEIFENG WANG, Shenzhen (CN); Jing Li, Shanghai (CN); Qing Zhao, Xi’an (CN)

(73) Assignee: HUAWEI TECHNOLOGIES CO., LTD., Shenzhen (CN)

(21) Appl. No.: 19/052,305

(22) Filed: Feb. 13, 2025

Related U.S. Application Data
(63) Continuation of application No. PCT/CN2022/115791, filed on Aug. 30, 2022.

(51) Int. Cl. H01Q 19/19

(52) U.S. Cl. CPC H01Q 19/19

(57) ABSTRACT

This application provides an antenna. The antenna includes a primary reflector, a secondary reflector, and a feed. The primary reflector and the secondary reflector are disposed opposite to each other, the feed has a plurality of radiation ports, and electromagnetic waves emitted by the plurality of radiation ports are reflected by the secondary reflector to the primary reflector. The secondary reflector includes a plurality of curved surfaces, virtual focuses of a plurality of curved surfaces do not coincide, and the plurality of radiation ports are located in an area formed by a plurality of virtual focuses. In the antenna can take account of a plurality of radiation ports at different positions, so that electromagnetic waves generated by the radiation ports at different positions are efficiently reflected. In this way, radiation efficiency of the antenna can be effectively ensured.

### CROSS-REFERENCE TO RELATED APPLICATIONS

This application is a continuation of International Application No. PCT/CN2022/115791, filed on Aug. 30, 2022, the disclosure of which is hereby incorporated by reference in its entirety.

### TECHNICAL FIELD

This application relates to the field of communication technologies, and in particular, to an antenna and a communication device.

### BACKGROUND

Reflector antennas have characteristics such as simple structures, ease of design, and excellent performance, and are widely used in fields such as satellite communication, remote communication, tracking radar, and meteorological radar. A reflector antenna mainly includes a feed, a primary reflector, and a secondary reflector. A working principle of the reflector antenna is roughly as follows: An electromagnetic wave generated by a radiation port of the feed is reflected by the secondary reflector and the primary reflector and then propagated to the outside. In an ideal case, when the radiation port is located at a specific position, antenna efficiency is high. With continuous development of communication technologies, a quantity of radiation ports included in a feed increases. Consequently, radiation ports at different positions deviate from the specific position, reducing antenna efficiency.

### SUMMARY

This application provides an antenna with high radiation efficiency and a communication device.

On one hand, this application provides an antenna. The antenna may include a primary reflector, a secondary reflector, and a feed. The primary reflector and the secondary reflector are disposed opposite to each other, the feed has a plurality of radiation ports, and electromagnetic waves emitted by the plurality of radiation ports are reflected by the secondary reflector to the primary reflector. An external electromagnetic wave may be propagated to the radiation port through the primary reflector and the secondary reflector. The secondary reflector includes a plurality of curved surfaces, virtual focuses of a plurality of curved surfaces do not coincide, and the plurality of radiation ports are located in an area formed by a plurality of virtual focuses. In the antenna provided in this application, the secondary reflector can provide a plurality of virtual focuses at different positions, and can take account of a plurality of radiation ports at different positions, so that electromagnetic waves generated by the radiation ports at different positions are efficiently reflected. In this way, radiation efficiency of the antenna can be effectively ensured.

In an example, focal axes of the plurality of curved surfaces in the secondary reflector may coincide, to reduce difficulty in modulating a signal.

When the focal axes of the curved surfaces coincide, the plurality of virtual focuses are located in a same straight line. The area in which the plurality of radiation ports are located and that is formed by the plurality of virtual focuses is a set of surfaces that are between any two virtual focuses and that are perpendicular to the focal axis.

When the curved surface is disposed, each curved surface may be a curved surface that is rotationally symmetric around the focal axis.

As an example, a plurality of curved surfaces may be disposed in sequence from the focal axis to a direction away from the focal axis.

When the radiation ports are disposed, a plurality of radiation ports may be disposed rotationally symmetrically around the focal axis, so that the plurality of radiation ports are disposed in correspondences with the curved surfaces. This helps improve radiation efficiency of the antenna.

In addition, an included angle between a radiation direction of the radiation port and the focal axis is greater than or equal to 0° and less than or equal to 45°, to ensure radiation efficiency of the antenna.

In addition, a distance between the radiation port and the focal axis may be greater than or equal to 0 and less than or equal to 5λ. λ is a wavelength during propagation in space of an electromagnetic wave generated by the radiation port.

When the primary reflector is disposed, a focal axis of the primary reflector may coincide with the focal axes of the plurality of curved surfaces.

In addition, a real focus of the primary reflector may be located in an area formed by real focuses of the secondary reflector. The area formed by the real focuses is a set of surfaces that are between any two real focuses and that are perpendicular to the focal axis.

In another implementation, the focal axes of the plurality of curved surfaces in the secondary reflector may alternatively not coincide. This helps improve reflection efficiency for radiation ports at different positions.

During specific disposing, focal axes of at least two curved surfaces may not coincide, or focal axes of all curved surfaces may not coincide.

In addition, during disposing, a quantity of the radiation ports may be the same as a quantity of the disposed curved surfaces, so that the radiation ports and the virtual focuses of the curved surfaces may be disposed in a one-to-one correspondence, to improve efficiency of reflecting, by the secondary reflector, the electromagnetic waves generated by the radiation ports at different positions.

In addition, in an example, when focal axes of all curved surfaces do not coincide, real focuses of a plurality of curved surfaces may coincide, to improve reflection efficiency between the secondary reflector and the primary reflector.

Alternatively, in some examples, the real focuses of the secondary reflector may not coincide.

When the primary reflector and the secondary reflector are disposed, the real focus of the primary reflector may be located in an area formed by the real focuses of the secondary reflector.

In addition, during specific disposing, the antenna may further include a feed network, and the feed network may be in a feed connection with the feed. The feed network may include a phase shifter, and phases of the electromagnetic waves generated by the radiation ports at different positions of the feed are adjusted by using the phase shifter, to implement an objective of beam scanning.

On the other side, this application further provides a communication device. The communication device may include a support and any one of the foregoing antennas. The primary reflector may be fastened to the support, so that the antenna is fastened at a required position.

During specific application, the communication device may be a microwave relay station, a radar, or the like. A specific type of the communication device is not limited in this application.

### BRIEF DESCRIPTION OF DRAWINGS

FIG. 1 is a diagram of an application scenario of an antenna according to an embodiment of this application;

FIG. 2 is a diagram of a structure of a conventional reflector antenna according to this application;

FIG. 3 is a diagram of a structure of another conventional reflector antenna according to this application;

FIG. 4 is a diagram of a three-dimensional structure of an antenna according to an embodiment of this application;

FIG. 5 is a diagram of a structure of a side surface of an antenna according to an embodiment of this application;

FIG. 6 is a diagram of a structure of a side surface of a curved surface according to an embodiment of this application;

FIG. 7 is a diagram of a structure of a side surface of another curved surface according to an embodiment of this application;

FIG. 8 is a diagram of a structure of a side surface of a secondary reflector according to an embodiment of this application;

FIG. 9 is a diagram of a planar structure of a secondary reflector according to an embodiment of this application;

FIG. 10 is a diagram of a structure of a side surface of another secondary reflector according to an embodiment of this application;

FIG. 11 is a diagram of a planar structure of another secondary reflector according to an embodiment of this application;

FIG. 12 is a diagram of a structure of a side surface of still another secondary reflector according to an embodiment of this application;

FIG. 13 is a diagram of a planar structure of still another secondary reflector according to an embodiment of this application;

FIG. 14 is a diagram of a structure of a side surface of another antenna according to an embodiment of this application;

FIG. 15 is a diagram in which structures of a radiation port and a focal axis of a secondary reflector are displayed according to an embodiment of this application;

FIG. 16 is a diagram of a structure of a side surface of another secondary reflector according to an embodiment of this application;

FIG. 17 is a diagram of a structure of a side surface of another secondary reflector according to an embodiment of this application;

FIG. 18 is a diagram of a structure of a side surface of another secondary reflector according to an embodiment of this application;

FIG. 19 is a diagram of structures of side surfaces of another primary reflector and another secondary reflector according to an embodiment of this application;

FIG. 20 is a diagram of structures of side surfaces of another primary reflector and another secondary reflector according to an embodiment of this application;

FIG. 21 is a diagram of structures of side surfaces of another primary reflector and another secondary reflector according to an embodiment of this application;

FIG. 22 is a diagram in which structures of side surfaces of a radiation port and a secondary reflector are displayed according to an embodiment of this application;

FIG. 23 is a diagram in which structures of side surfaces of a radiation port and a secondary reflector are displayed according to an embodiment of this application;

FIG. 24 is a diagram of a structure of a microwave relay station according to an embodiment of this application; and

FIG. 25 is a block diagram of a structure of a microwave relay station according to an embodiment of this application.

### DESCRIPTION OF EMBODIMENTS

To make the objectives, technical solutions, and advantages of this application clearer, the following further describes this application in detail with reference to the accompanying drawings.

To facilitate understanding of the antenna provided in embodiments of this application, the following first describes an application scenario of the antenna.

The antenna provided in embodiments of this application is a reflector antenna, may be used in a microwave communication transmission scenario, and is configured to emit an electromagnetic wave or receive an electromagnetic wave, to implement a wireless communication function.

For example, in the microwave communication scenario, a plurality of microwave relay stations may be included, and the plurality of microwave relay stations may form a microwave transmission link.

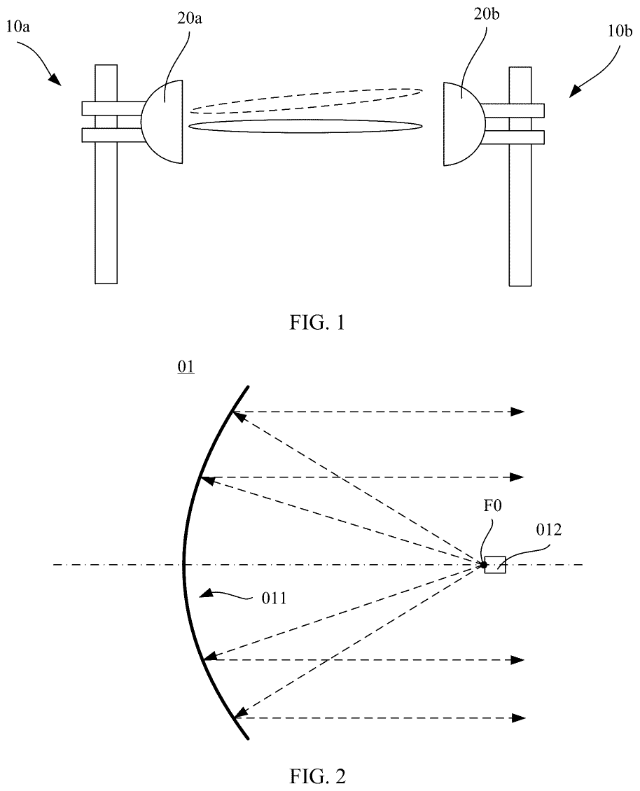

As shown in FIG. 1, two microwave relay stations are used as an example. An antenna may be disposed in each of a microwave relay station 10a and a microwave relay station 10b. An electrical signal of the microwave relay station 10a may be emitted toward the microwave relay station 10b through an electromagnetic wave generated by an antenna 20a. An antenna 20b in the microwave relay station 10b may receive the electromagnetic wave emitted by the antenna 20a. Certainly, an electrical signal of the microwave relay station 10b may be emitted to the microwave relay station 10a through an electromagnetic wave generated by the antenna 20b, and the antenna 20a in the microwave relay station 10a may receive the electromagnetic wave emitted by the antenna 20b, so that communication between the two microwave relay stations can be implemented. During actual application, three or more microwave relay stations may form the transmission link, to implement long-distance communication.

FIG. 2 shows a conventional reflector antenna 01 according to this application. The reflector antenna 01 may include a reflector 011 and a feed 012. The feed 012 is configured to generate an electromagnetic wave, and the electromagnetic wave is propagated to the outside after being reflected by the reflector 011. Alternatively, after being reflected by the reflector 011, an external electromagnetic wave may be received by the feed 012. Theoretically, after any ray starting from a real focus F0 of the reflector 011 is reflected by the reflector 011, an obtained reflection line is parallel to a focal axis (as shown by a stippled line in the figure) of the reflector 011. Therefore, in an ideal case, a radiation port of the feed 012 is usually located at the real focus F0 of the reflector 011, so that the antenna 01 can have high efficiency.

In microwave communication, a frequency range of an electromagnetic wave generated by the feed 012 (namely, a working frequency of the antenna 01) is approximately 300 MHz to 3000 GHz. With continuous development of communication technologies and continuous improvement of user requirements, the working frequency of the antenna 01 also increases. However, when the working frequency of the antenna 01 increases, a gain of the antenna 01 also increases, and a half-power angle of the antenna 01 becomes narrower. In a transmission link, when a specific antenna (for example, the antenna 20a in the microwave relay station 10a in FIG. 1) slightly shakes or is shifted due to a strong wind, an earthquake, or the like, the antenna cannot be aligned with an adjacent antenna (for example, the antenna 20b in the microwave relay station 10b), which causes interruption of the transmission link.

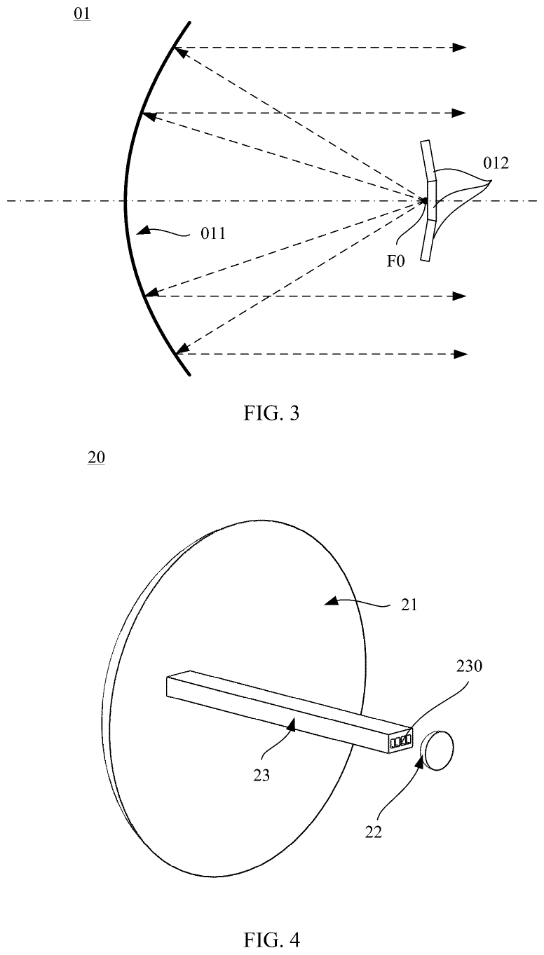

Based on this, as shown in FIG. 3, some manufacturers start to use a feed array. In the example in FIG. 3, the feed array may include three feeds 012. Phases of different feeds 012 are changed, so that after electromagnetic waves generated by the feeds 012 are reflected by the reflective surface 011, in-phase superposition is performed at a specified angle to perform beam combination, to achieve an objective of beam scanning, so that a beam direction of the antenna 01 can be adjusted.

However, in a current solution, if a size of the feed array is excessively large, the reflector 011 is obviously blocked, and consequently radiation efficiency of the antenna 01 is reduced. In addition, because there are a large quantity of feeds 012, it can only be ensured that a radiation port of one of the feeds 012 is located at the real focus F0 of the reflector 011, and radiation ports of other feeds 012 deviate from the real focus F0 of the reflector 011, and consequently, the reflector 011 has low efficiency of reflecting electromagnetic waves generated by radiation ports at different positions, which is not conducive to ensuring of radiation efficiency of the antenna 01.

In view of this, embodiments of this application provide an antenna with high radiation efficiency.

To make the objectives, technical solutions, and advantages of this application clearer, the following further describes this application in detail with reference to the accompanying drawings and specific embodiments.

Terms used in the following embodiments are merely intended to describe specific embodiments, but are not intended to limit this application. Terms “one”, “a”, and “this” of singular forms used in this specification and the appended claims of this application are also intended to further include expressions such as “one or more”, unless otherwise specified in the context clearly. It should be further understood that, in the following embodiments of this application, “at least one” means one, two, or more.

Reference to “an embodiment” or the like described in this specification means that one or more embodiments of this application include a specific feature, structure, or characteristic described with reference to the embodiment. Therefore, in this specification, statements, such as “in an embodiment”, “in some embodiments”, and “in other embodiments”, that appear at different places do not necessarily mean referring to a same embodiment. Instead, the statements mean referring to “one or more but not all of embodiments”, unless otherwise specifically emphasized in another manner. The terms “include”, “have”, and variants of the terms all mean “include but are not limited to”, unless otherwise specifically emphasized in another manner.

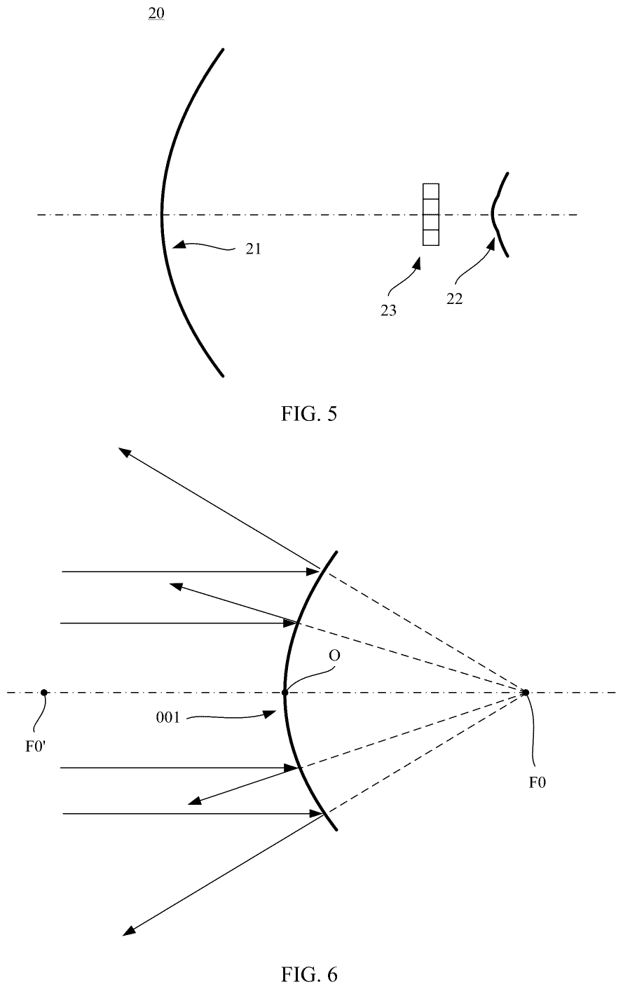

As shown in FIG. 4 and FIG. 5, in an example provided in this application, an antenna 20 may include a primary reflector 21, a secondary reflector 22, and a feed 23. The secondary reflector 22 and the primary reflector 21 are disposed opposite to each other. The feed 23 has a plurality of radiation ports 230 configured to emit electromagnetic waves, and an electromagnetic wave emitted by each radiation port 230 may be reflected by the secondary reflector 22 to the primary reflector 21. The secondary reflector 22 includes a plurality of curved surfaces, virtual focuses of a plurality of curved surfaces do not coincide, and the plurality of radiation ports 230 are all located in an area formed by a plurality of virtual focuses. In the antenna provided in this application, the feed 23 includes a plurality of radiation ports 230. In addition, the secondary reflector 22 can provide a plurality of virtual focuses at different positions, and can take account of a plurality of radiation ports 230 at different positions, so that electromagnetic waves generated by the radiation ports 230 at different positions are efficiently reflected. In this way, radiation efficiency of the antenna can be effectively ensured.

It may be understood that, that the secondary reflector 22 can take account of a plurality of radiation ports 230 at different positions includes: An electromagnetic wave generated by a radiation port 230 at a specific position can be reflected by at least two curved surfaces in the secondary reflector 22. Alternatively, an electromagnetic wave generated by a radiation port 230 at a specific position can be reflected by a corresponding single curved surface.

The primary reflector 21 is a part of a surface of a specific physical structure. For example, when the physical structure is a hemispherical metal plate, a concave surface of the metal plate may be used as the primary reflector 21. Certainly, during actual application, the primary reflector 21 may be a parabolic surface, an ellipsoidal surface, a hyperbolic surface, a spherical surface, or the like. A specific shape of the primary reflector 21 is not limited in this application.

In addition, the secondary reflector 22 is a part of a surface of a specific physical structure. For example, when the physical structure is a roughly hemispherical metal plate, a convex surface of the metal plate may be used as the secondary reflector 22. During actual application, a quantity and structure types of curved surfaces included in the secondary reflector 22 may be diversified. The following uses an example for description. Details are not described herein.

That the primary reflector 21 and the secondary reflector 22 are disposed opposite to each other means that the primary reflector 21 and the secondary reflector 22 are disposed face to face. During actual application, in some directions, an electromagnetic wave emitted to the primary reflector 21 can be emitted to the secondary reflector 22 after being reflected by the primary reflector 21. In addition, in some directions, an electromagnetic wave emitted to the secondary reflector 22 can be emitted to the primary reflector 21 after being reflected by the secondary reflector 22.

During actual application, the feed 23 with a high radiation gain may be used, so that an electromagnetic wave generated by the feed 23 can be efficiently emitted to the secondary reflector 22. In this way, radiation efficiency of the antenna 20 can be improved. A shape of a cross section of each radiation port 230 may be a circle, a rectangle, an ellipse, or the like. In addition, sizes of the radiation ports 230 may be the same or different. A type of the feed 23 and a quantity and sizes of radiation ports 230 are not limited in this application.

For ease of understanding of the primary reflector and the secondary reflector provided in embodiments of this application, the following first describe structural parameters of a curved surface.

As shown in FIG. 6, when a curved surface 001 is of a structure type of a convex surface, the curved surface 001 has a focal axis (as shown by a stippled line in the figure). The focal axis may also be understood as a principal axis, and is a central rotation axis of the curved surface 001. In other words, the curved surface 001 is a rotation surface using the focal axis as an axis. After parallel beams that are parallel to the focal axis are emitted to the curved surface 001, the parallel beams are reflected by the curved surface 001 and become reflected waves. Reverse extension lines of the reflected waves in different directions converge at one focus, and the focus may be referred to as the real focus F0. A point symmetric to the real focus F0 with respect to a vertex O of the curved surface 001 may be defined as a virtual focus F0′ of the curved surface 001. The vertex O of the curved surface 001 is an intersection point between the focal axis and the curved surface 001. During actual application, a type of the curved surface 001 may be a parabolic surface, an ellipsoidal surface, a hyperbolic surface, a spherical surface, or the like. It may be understood that, in a conventional definition, a parabolic surface has a real focus and a virtual focus. Therefore, the foregoing definitions of the real focus and the virtual focus are equivalent to the conventional definition of the parabolic surface. However, in a conventional definition, a curved surface such as an ellipsoidal surface, a hyperbolic surface, or a spherical surface only includes a real focus and does not include a virtual focus. Therefore, in this application, the virtual focus F0′ may be understood as a point symmetric to the real focus F0 with respect to the vertex O of the curved surface 001. Certainly, during actual application, the curved surface 001 may alternatively be of another type of surface structure. Details are not described herein.

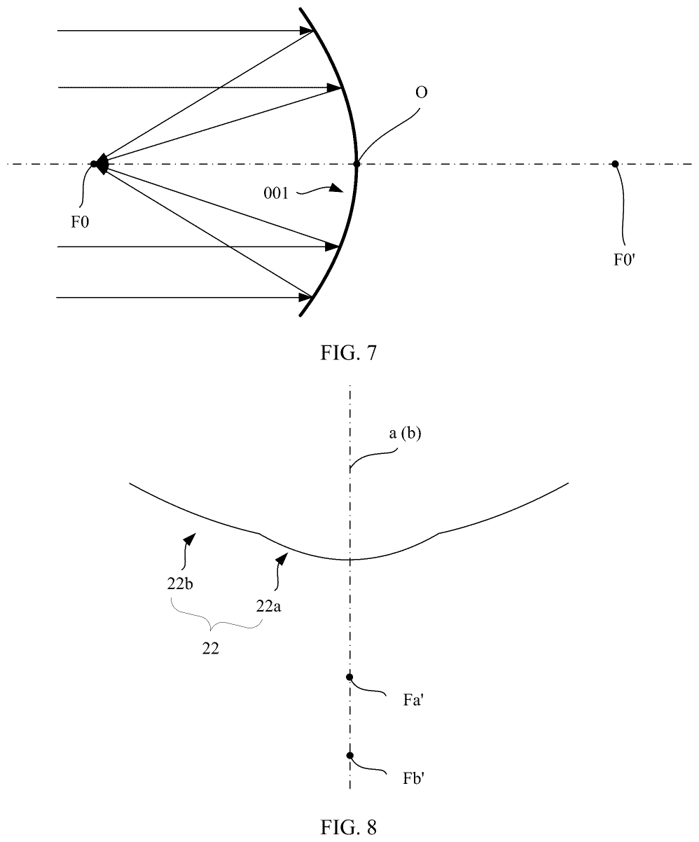

As shown in FIG. 7, when the curved surface 001 is of a structure type of a concave surface, the curved surface 001 has a focal axis (as shown by a stippled line in the figure). The focal axis may also be understood as a principal axis, and is a central rotation axis of the curved surface 001. In other words, the curved surface 001 is a rotation surface using the focal axis as an axis. After parallel beams that are parallel to the focal axis are emitted to the curved surface 001, the parallel beams are reflected by the curved surface 001 and become reflected waves, and the reflected waves in different directions converge at one focus. Because the focus is formed by convergence of the beams, the focus is usually referred to as the real focus F0. A point symmetric to the real focus F0 with respect to the vertex O of the curved surface 001 may be defined as the virtual focus F0′ of the curved surface 001. The vertex O of the curved surface 001 is an intersection point between the focal axis and the curved surface 001. During actual application, a type of the curved surface 001 may be a parabolic surface, an ellipsoidal surface, a hyperbolic surface, a spherical surface, or the like. It may be understood that, in a conventional definition, a parabolic surface has a real focus and a virtual focus. Therefore, the foregoing definitions of the real focus and the virtual focus are equivalent to the conventional definition of the parabolic surface. However, in a conventional definition, a curved surface such as an ellipsoidal surface, a hyperbolic surface, or a spherical surface only includes a real focus and does not include a virtual focus. Therefore, in this application, the virtual focus F0′ may be understood as a point symmetric to the real focus F0 with respect to the vertex O of the curved surface 001. Certainly, during actual application, the curved surface 001 may alternatively be of another type of surface structure. Details are not described herein.

In the antenna 20 provided in this embodiment of this application, when the secondary reflector 22 is disposed, the secondary reflector 22 may include at least one of a parabolic surface, an ellipsoidal surface, a hyperbolic surface, or a spherical surface, or may include a curved surface of another type.

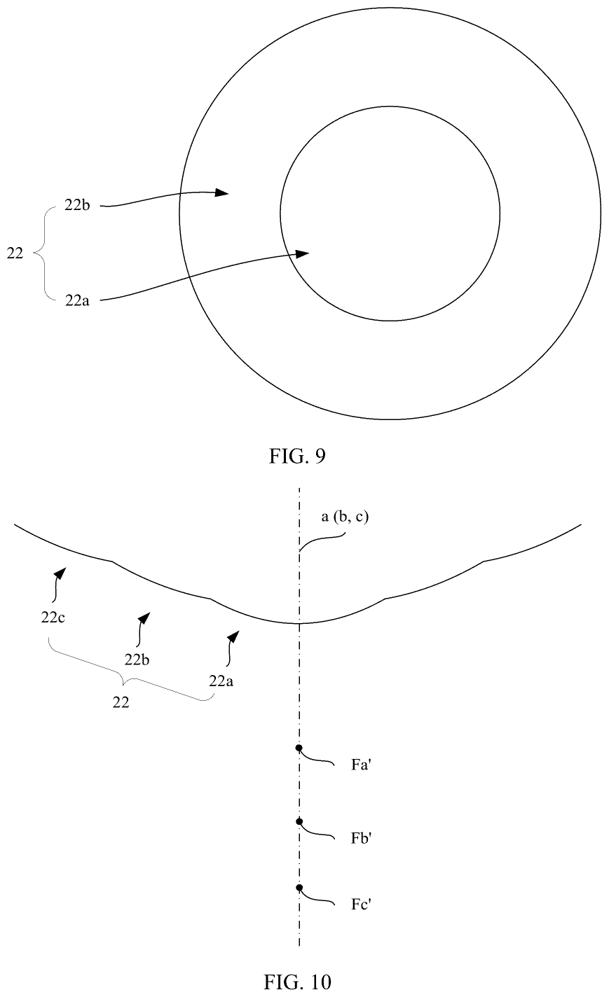

As shown in FIG. 8 and FIG. 9, in an example provided in this application, the secondary reflector 22 may include two curved surfaces, or it may be understood that the secondary reflector 22 is formed by two curved surfaces. The two curved surfaces are a curved surface 22a and a curved surface 22b, a virtual focus of the curved surface 22a is Fa′, and a virtual focus of the curved surface 22b is Fb′.

In the example shown in the figure, a focal axis a of the curved surface 22a coincides with a focal axis b of the curved surface 22b, and the virtual focus Fa′ of the curved surface 22a does not coincide with the virtual focus Fb′ of the curved surface 22b.

Specifically, in the secondary reflector 22 shown in FIG. 8 and FIG. 9, both the curved surface 22a and the curved surface 22b are curved surfaces that are rotationally symmetric around the focal axis a (or b), and the curved surface 22a and the curved surface 22b are disposed in sequence from the focal axis a (or b) to a direction away from the focal axis a (or b). Alternatively, it may be understood that the curved surface 22a and the curved surface 22b are of a nested structure. In other words, a contour of the curved surface 22a is relatively small, a contour of the curved surface 22b is relatively large, and the curved surface 22a is disposed closer to the focal axis than the curved surface 22b.

In an example provided in this application, the secondary reflector 22 includes two curved surfaces: the curved surface 22a and the curved surface 22b. The curved surface 22a is approximately in a disk shape, and the curved surface 22b is approximately in a circular ring shape.

The curved surface 22a may be a parabolic surface, a spherical surface, or the like, and the curved surface 22b may also be a parabolic surface, a spherical surface, or the like. During actual application, types of the curved surface 22a and the curved surface 22b may be flexibly selected according to an actual requirement. In addition, types of the curved surface 22a and the curved surface 22b may be the same or different. This is not limited in this application.

Certainly, in another example, the secondary reflector 22 may alternatively include three or more curved surfaces.

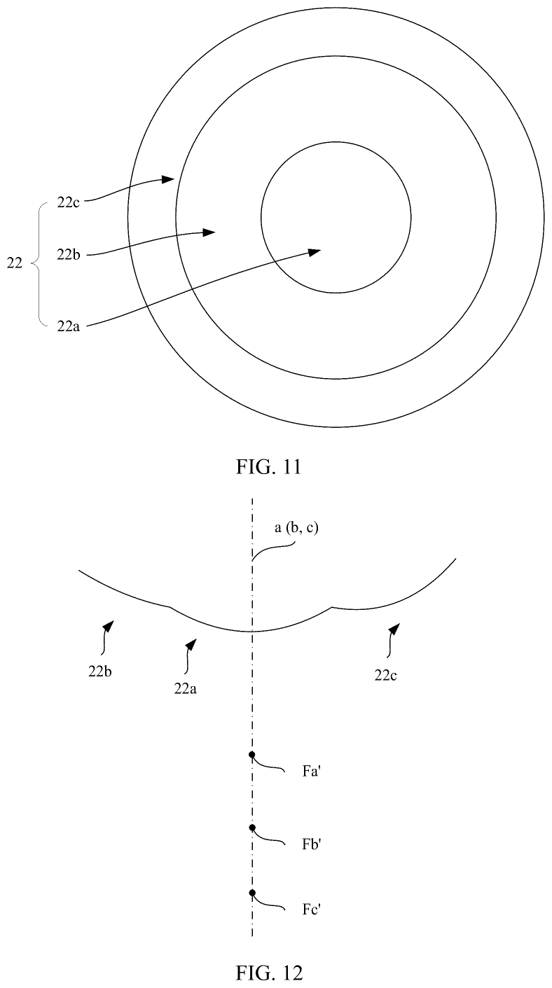

For example, as shown in FIG. 10 and FIG. 11, in another example provided in this application, the secondary reflector 22 may include three curved surfaces: the curved surface 22a, the curved surface 22b, and a curved surface 22c. Specifically, the focal axis a of the curved surface 22a, the focal axis b of the curved surface 22b, and a focal axis c of the curved surface 22c all coincide. The virtual focus of the curved surface 22a is Fa′, the virtual focus of the curved surface 22b is Fb′, and a virtual focus of the curved surface 22c is Fc′. The curved surface 22a is approximately in a disk shape, and both the curved surface 22b and the curved surface 22c are approximately in circular ring shapes, and are nested in sequence.

Certainly, in another example, some curved surfaces may alternatively be of non-centro-symmetric structures.

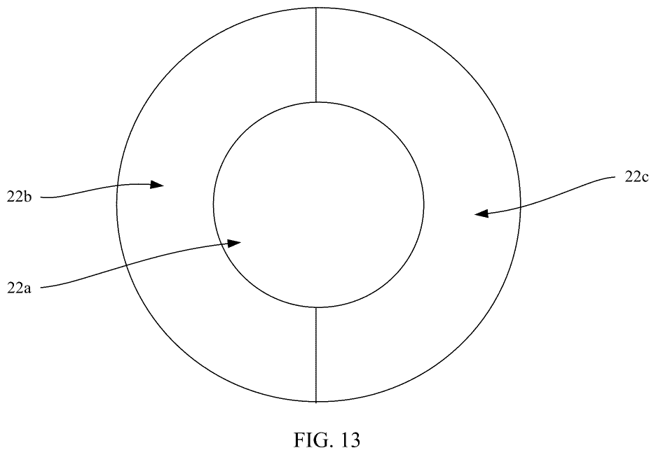

For example, as shown in FIG. 12 and FIG. 13, in another example provided in this application, the secondary reflector 22 includes three curved surfaces: the curved surface 22a, the curved surface 22b, and the curved surface 22c. The focal axis a of the curved surface 22a, the focal axis b of the curved surface 22b, and the focal axis c of the curved surface 22c all coincide. The virtual focus of the curved surface 22a is Fa′, the virtual focus of the curved surface 22b is Fb′, and the virtual focus of the curved surface 22c is Fc′. The curved surface 22a is approximately in a disk shape, and both the curved surface 22b and the curved surface 22c are approximately in semi-circular ring shapes. In other words, the curved surface 22a is of a centro-symmetric structure, and the curved surface 22b and the curved surface 22c are of non-centro-symmetric structures. It should be noted that, although the curved surface 22b and the curved surface 22c are of non-centro-symmetric structures, the curved surface 22b is still a curved surface using the focal axis b as a rotation axis. Correspondingly, although the curved surface 22c is of a non-centro-symmetric structure, the curved surface 22c is still a curved surface using the focal axis c as a rotation axis.

When the feed and the secondary reflector are disposed, the radiation ports of the feed may be located in an area formed by a plurality of virtual focuses.

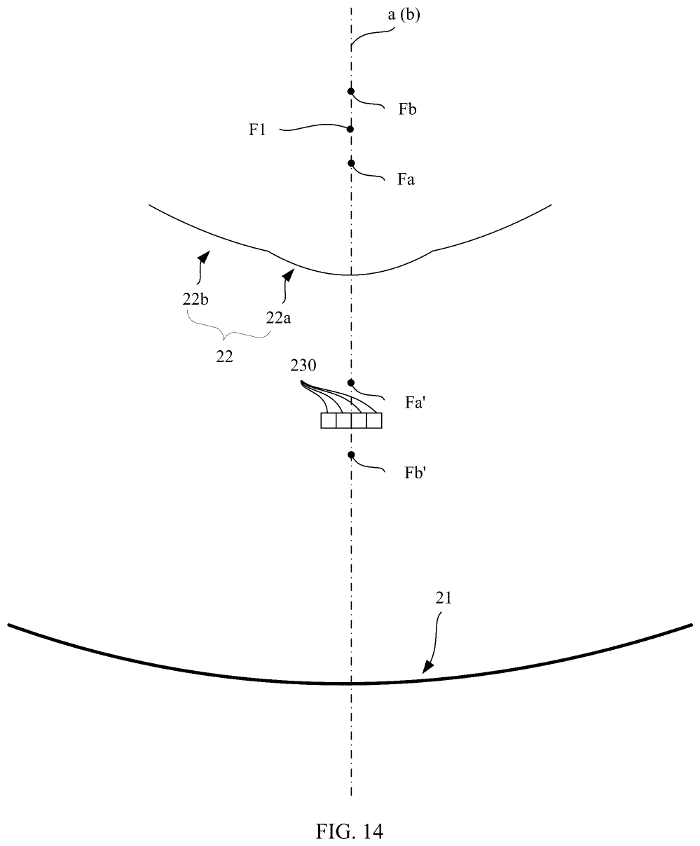

Specifically, as shown in FIG. 14, the secondary reflector 22 includes two curved surfaces: the curved surface 22a and the curved surface 22b. The focal axis a of the curved surface 22a coincides with the focal axis b of the curved surface 22b. The virtual focus Fa′ of the curved surface 22a and the virtual focus Fb′ of the curved surface 22b are located on a same focal axis.

The virtual focus Fa′ and the virtual focus Fb′ may form one focal segment, and Fa′ and Fb′ are two endpoints of the focal segment respectively. An area formed by the virtual focus Fa′ and the virtual focus Fb′ is a set of surfaces that are between the virtual focus Fa′ and the virtual focus Fb′ and that are perpendicular to the focal axis a (b).

It may be understood that the foregoing uses only two curved surfaces as an example for description. When there are three or more curved surfaces, the radiation port 230 of the feed may be located in an area formed by virtual focuses of any two curved surfaces.

In addition, when the radiation ports 230 of the feed are disposed, a plurality of radiation ports 230 may be disposed by using the focal axis as a rotation axis.

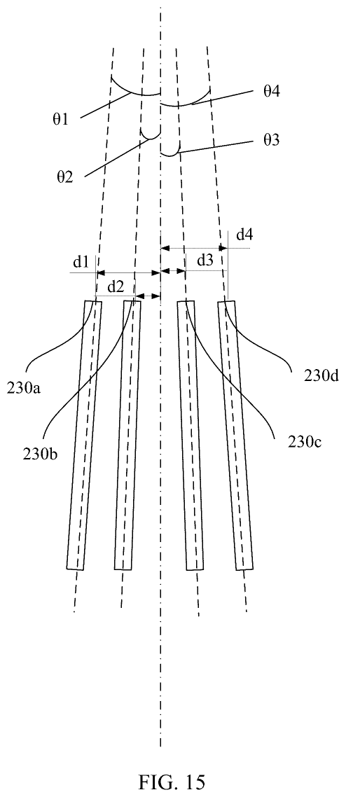

As shown in FIG. 15, when the radiation ports are disposed, an orientation and disposition spacing of each radiation port may also be diversified.

For example, in an example provided in this application, there are four radiation ports: a radiation port 230a, a radiation port 230b, a radiation port 230c, and a radiation port 230d. The radiation port 230a and the radiation port 230d are disposed symmetrically around the focal axis, and the radiation port 230b and the radiation port 230c are disposed symmetrically around the focal axis.

During specific disposing, an included angle θ1 between a radiation direction of the radiation port 230a and the focal axis may be greater than or equal to 0° and less than or equal to 45°. The radiation direction of the radiation port 230a is a propagation direction of an electromagnetic wave generated by the radiation port 230a. Certainly, θ1 may also be understood as a direction perpendicular to a port surface of the radiation port 230a. Correspondingly, an included angle θ2 between a radiation direction of the radiation port 230b and the focal axis may be greater than or equal to 0° and less than or equal to 45°. The radiation direction of the radiation port 230b is a propagation direction of an electromagnetic wave generated by the radiation port 230b. Certainly, θ2 may also be understood as a direction perpendicular to a port surface of the radiation port 230b. Correspondingly, an included angle θ3 between a radiation direction of the radiation port 230c and the focal axis may be greater than or equal to 0° and less than or equal to 45°. The radiation direction of the radiation port 230c is a propagation direction of an electromagnetic wave generated by the radiation port 230c. Certainly, θ3 may also be understood as a direction perpendicular to a port surface of the radiation port 230c. Correspondingly, an included angle θ4 between a radiation direction of the radiation port 230d and the focal axis may be greater than or equal to 0° and less than or equal to 45°. The radiation direction of the radiation port 230d is a propagation direction of an electromagnetic wave generated by the radiation port 230d. Certainly, θ4 may also be understood as a direction perpendicular to a port surface of the radiation port 230d.

The radiation port 230a and the radiation port 230d are disposed symmetrically with respect to the focal axis. Therefore, θ1 and θ4 may be the same. The radiation port 230b and the radiation port 230c are disposed symmetrically with respect to the focal axis. Therefore, θ2 and θ3 may be the same.

Certainly, during actual application, specific values of θ1, θ2, θ3, and θ4 may be properly specified based on a scanning angle range of the antenna. Details are not described herein.

In addition, a distance d1 between the radiation port 230a and the focal axis may be greater than or equal to 0 and less than or equal to 5λ. λ is a wavelength during propagation in space of an electromagnetic wave generated by the radiation port 230a. A distance d2 between the radiation port 230b and the focal axis may be greater than or equal to 0 and less than or equal to 5λ. λ is a wavelength during propagation in space of an electromagnetic wave generated by the radiation port 230b. A distance d3 between the radiation port 230c and the focal axis may be greater than or equal to 0 and less than or equal to 5λ. λ is a wavelength during propagation in space of an electromagnetic wave generated by the radiation port 230c. A distance d4 between the radiation port 230d and the focal axis may be greater than or equal to 0 and less than or equal to 5λ. λ is a wavelength during propagation in space of an electromagnetic wave generated by the radiation port 230d.

The radiation port 230a and the radiation port 230d are disposed symmetrically with respect to the focal axis. Therefore, d1 and d4 may be the same. The radiation port 230b and the radiation port 230c are disposed symmetrically with respect to the focal axis. Therefore, d2 and d3 may be the same.

Certainly, during actual application, specific values of d1, d2, d3, and d4 may be properly specified based on a scanning angle range of the antenna. Details are not described herein.

In addition, a quantity of the radiation ports 230 may be the same as or different from a quantity of the curved surfaces. This is not limited in this application.

Certainly, in some cases during actual application, the radiation port 230 of the feed may alternatively be located outside the area formed by the plurality of virtual focuses. Details are not described herein.

When the primary reflector 21 is disposed, a real focus F1 of the primary reflector 21 may be located in an area formed by a plurality of real focuses of the secondary reflector 22.

Specifically, as shown in FIG. 14, the secondary reflector 22 includes two curved surfaces: the curved surface 22a and the curved surface 22b. The focal axis a of the curved surface 22a coincides with the focal axis b of the curved surface 22b. A real focus Fa of the curved surface 22a and a real focus Fb of the curved surface 22b are located on a same focal axis.

The real focus Fa and the real focus Fb may form one focal segment, and Fa and Fb are two endpoints of the focal segment respectively. An area formed by the real focus Fa and the real focus Fb is a set of surfaces that are between the real focus Fa and the real focus Fb and that are perpendicular to the focal axis a (b).

It may be understood that the foregoing uses only two curved surfaces as an example for description. When there are three or more curved surfaces, the real focus F1 of the primary reflector may be located in an area formed by real focuses of any two curved surfaces.

Certainly, in some cases during actual application, the real focus F1 of the primary reflector may alternatively be located outside the area formed by the plurality of virtual focuses. Details are not described herein.

It may be understood that, in the examples shown in FIG. 8 to FIG. 14, the secondary reflector 22 has one focal axis. In other words, focal axes of the plurality of curved surfaces all coincide. Certainly, in some other examples, the focal axes of the plurality of curved surfaces may alternatively be disposed at an included angle.

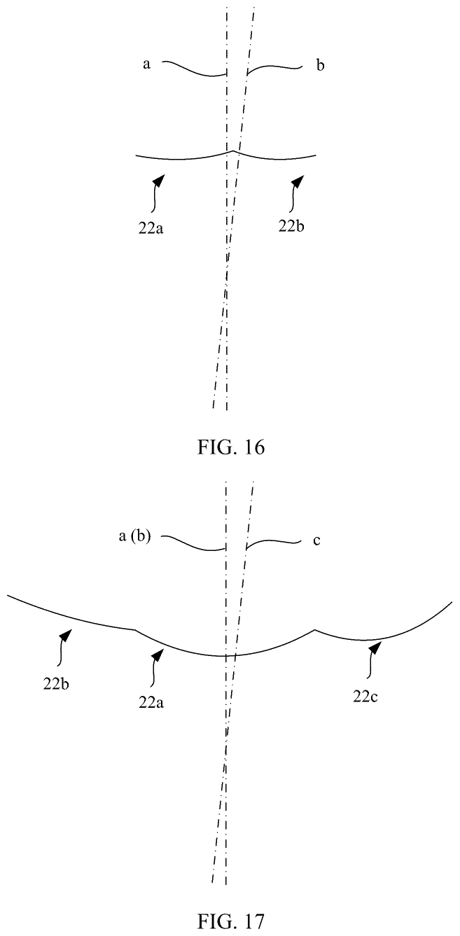

For example, as shown in FIG. 16, in an example provided in this application, the secondary reflector 22 includes two curved surfaces: the curved surface 22a and the curved surface 22b, and the focal axis a of the curved surface 22a does not coincide with the focal axis b of the curved surface 22b.

It may be understood that, during actual application, the secondary reflector 22 may include three or more curved surfaces, and each curved surface has a respective focal axis. During disposing, in the three or more curved surfaces, focal axes of at least two curved surfaces may be disposed as an included angle.

For example, the secondary reflector 22 includes three curved surfaces.

As shown in FIG. 17, the three curved surfaces are respectively the curved surface 22a, the curved surface 22b, and the curved surface 22c. The focal axis a of the curved surface 22a coincides with the focal axis b of the curved surface 22b, and the focal axis c of the curved surface 22c is disposed at an included angle with each of the focal axis a of the curved surface 22a and the focal axis b of the curved surface 22b.

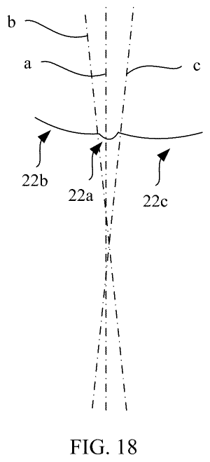

Alternatively, as shown in FIG. 18, the three curved surfaces are respectively the curved surface 22a, the curved surface 22b, and the curved surface 22c. The focal axis a of the curved surface 22a, the focal axis b of the curved surface 22b, and the focal axis c of the curved surface 22c are all disposed at included angles. In other words, the focal axis a of the curved surface 22a, the focal axis b of the curved surface 22b, and the focal axis c of the curved surface 22c do not coincide.

In summary, during actual application, when the secondary reflector 22 includes three or more curved surfaces, focal axes of at least two curved surfaces may be disposed at an included angle, or focal axes of all curved surfaces may be disposed at included angles.

During actual application, the focal axis a, the focal axis b, and the focal axis c may be located in a same plane. Alternatively, the focal axis a, the focal axis b, and the focal axis c may be located in different planes in space. This is not limited in this application.

In addition, during specific disposing, relative positions of real focuses of the plurality of curved surfaces may also be diversified.

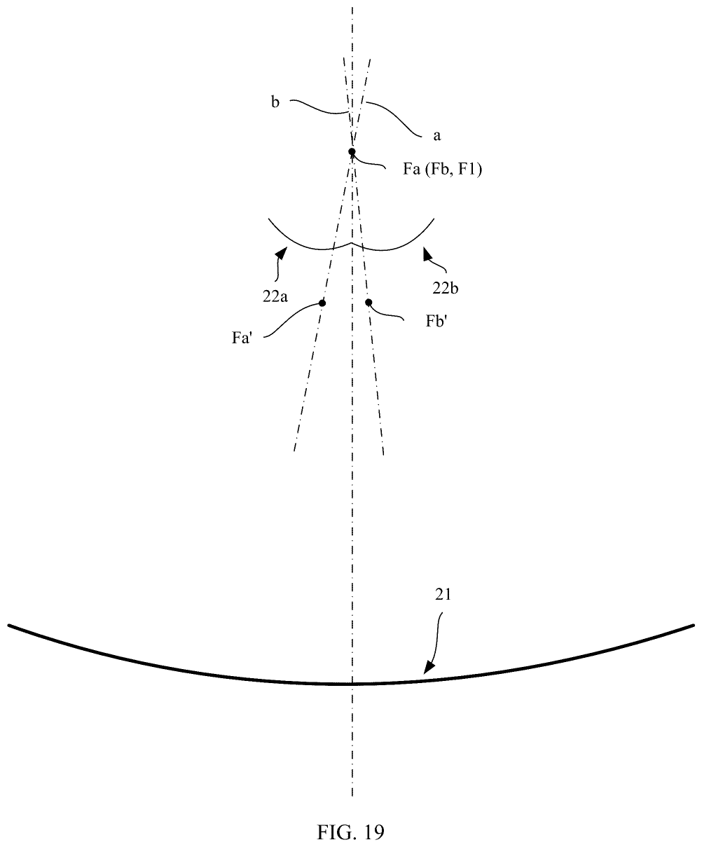

For example, as shown in FIG. 19, the secondary reflector 22 includes two curved surfaces. The focal axis a of the curved surface 22a and the focal axis b of the curved surface 22b are disposed at an included angle, and the real focus Fa of the curved surface 22a coincides with the real focus Fb of the curved surface 22b. This helps improve radiation efficiency of an antenna assembly.

For example, during actual application, one radiation port (not shown in FIG. 19) of the feed may be disposed at the virtual focus Fa′ of the curved surface 22a, and an electromagnetic wave generated by the radiation port may be efficiently reflected by the curved surface 22a, so that efficiency of reflecting an electromagnetic wave by the curved surface 22a can be effectively improved. Correspondingly, another port may be disposed at the virtual focus Fb′ of the curved surface 22b, so that efficiency of reflecting an electromagnetic wave by the curved surface 22b can be effectively improved. This helps improve radiation efficiency of the antenna assembly.

In addition, when the primary reflector 21 and the secondary reflector 22 are disposed, the real focus F1 of the primary reflector 21 may coincide with the real focus Fa (Fb) of the secondary reflector 22. This helps improve radiation efficiency of the antenna assembly.

For example, during actual application, when one radiation port (not shown in FIG. 19) of the feed is located after the virtual focus Fa′ of the curved surface 22a, an electromagnetic wave generated by the radiation port becomes a reflected wave after being reflected by the curved surface 22a. Correspondingly, when another radiation port (not shown in FIG. 19) of the feed is located after the virtual focus Fb′ of the curved surface 22b, an electromagnetic wave generated by the radiation port becomes a reflected wave after being reflected by the curved surface 22b. After the real focus F1 of the primary reflector 21, the real focus Fa of the curved surface 22a, and the real focus Fb of the curved surface 22b coincide, a reflected wave reflected by the secondary reflector may be efficiently reflected by the primary reflector 21. This helps improve radiation efficiency of the antenna assembly.

Certainly, in another example, the real focus F1 of the primary reflector 21 may alternatively not coincide with the real focuses (such as, Fa and Fb) of the secondary reflector 22. Alternatively, the focal axis a of the curved surface 22a and the focal axis b of the curved surface 22b may not intersect in space. Details are not described herein.

In addition, when the secondary reflector 22 includes a plurality of real focuses that do not coincide, the real focus F1 of the primary reflector 11 may be located in an area formed by a plurality of real focuses of the secondary reflector.

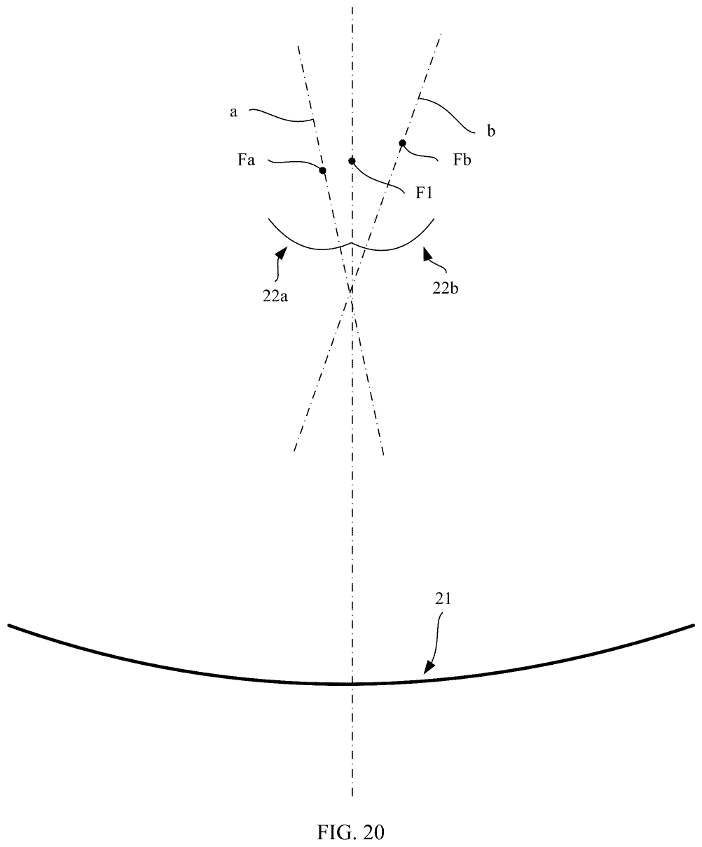

For example, as shown in FIG. 20, the secondary reflector includes two curved surfaces: the curved surface 22a and the curved surface 22b. The focal axis a of the curved surface 22a and the focal axis b of the curved surface 22b are disposed at an included angle. The real focus Fa of the curved surface 22a does not coincide with the real focus Fb of the curved surface 22b. The real focus F1 of the primary reflector 11 may be located in a straight line segment of Fa and Fb. In other words, an area formed by two real focuses may be understood as the straight line segment between the two real focuses.

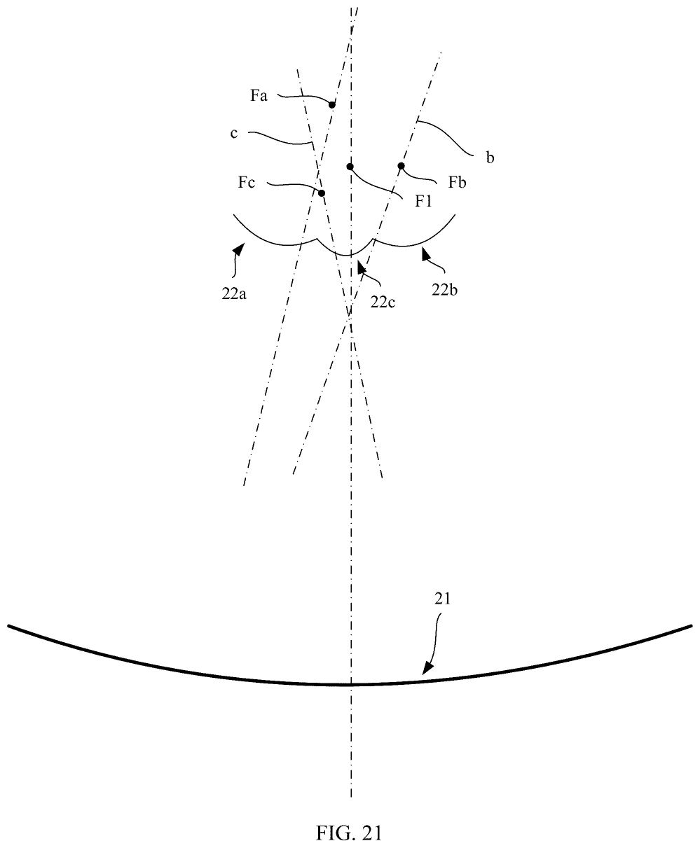

Alternatively, as shown in FIG. 21, the secondary reflector includes three curved surfaces: the curved surface 22a, the curved surface 2b, and the curved surface 22c. The focal axis a of the curved surface 22a, the focal axis b of the curved surface 22b, and the focal axis c of the curved surface 22c are disposed at included angles. The real focus Fa of the curved surface 22a, the real focus Fb of the curved surface 22b, and the real focus Fc of the curved surface 22c do not coincide. The real focus F1 of the primary reflector 11 may be located in a triangular area enclosed by Fa, Fb, and Fc. In other words, an area formed by a plurality of real focuses may be understood as an area enclosed by straight line segments between the plurality of real focuses.

It may be understood that, when the secondary reflector 22 includes four or more real focuses that do not coincide, the real focus F1 of the primary reflector 11 may be located in a line segment or an area formed by any quantity of real focuses of the secondary reflector. Details are not described herein.

In addition, when the secondary reflector 22 includes a plurality of virtual focuses, the radiation port of the feed may be located in an area formed by a plurality of virtual focuses of the secondary reflector.

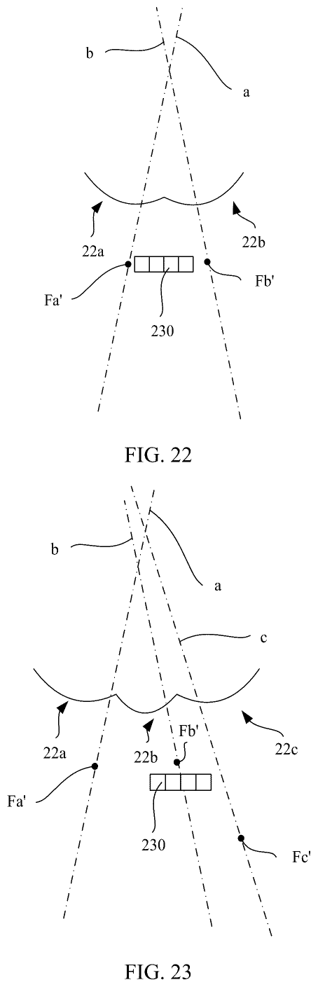

For example, as shown in FIG. 22, the secondary reflector includes two curved surfaces: the curved surface 22a and the curved surface 22b. The focal axis a of the curved surface 22a and the focal axis b of the curved surface 22b are disposed at an included angle. The virtual focus Fa′ of the curved surface 22a does not coincide with the virtual focus Fb′ of the curved surface 22b. The radiation port 230 may be located in a straight line segment of Fa′ and Fb′. In other words, an area formed by two virtual focuses may be understood as the straight line segment between the two virtual focuses.

Alternatively, as shown in FIG. 23, the secondary reflector includes three curved surfaces: the curved surface 22a, the curved surface 2b, and the curved surface 22c. The focal axis a of the curved surface 22a, the focal axis b of the curved surface 22b, and the focal axis c of the curved surface 22c are disposed at included angles. The virtual focus Fa′ of the curved surface 22a, the virtual focus Fb′ of the curved surface 22b, and the virtual focus Fc′ of the curved surface 22c do not coincide. The radiation port 230 may be located in a triangular area enclosed by Fa′, Fb′, and Fc′. In other words, an area formed by a plurality of virtual focuses may be understood as an area enclosed by straight line segments between the plurality of virtual focuses.

It may be understood that, when the secondary reflector 22 includes four or more virtual focuses that do not coincide, the radiation port 230 may be located in a line segment or an area formed by any quantity of virtual focuses of the secondary reflector. Details are not described herein.

Certainly, during actual application, relative positions of the primary reflector 11, the secondary reflector 22, and the radiation port 230 of the feed may be flexibly adjusted according to an actual requirement. For example, an orientation and a position of each radiation port 230 may be adaptively designed based on a scanning range of the antenna.

During actual application, the antenna may further include a feed network, and the feed network may be in a feed connection with the feed to process a signal of the antenna.

In addition, during actual application, the antenna may be used in a plurality of different types of communication devices.

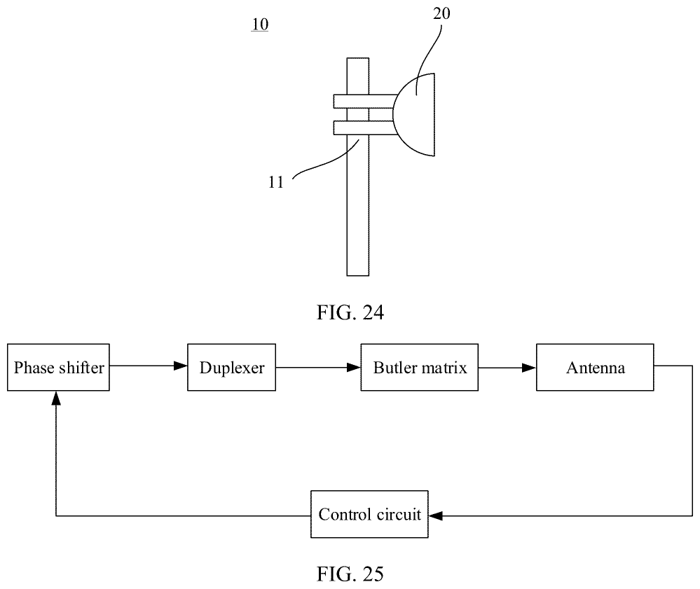

As shown in FIG. 24, the microwave relay station 10 is used as an example. In terms of a mechanical structure, the microwave relay station 10 may include a support 11 and the antenna 20. The antenna 20 may be fastened at a position such as a ground or a roof by using the support 11, to ensure stability of the antenna 20 and prevent the antenna 20 from shaking or another undesirable condition.

In addition, as shown in FIG. 25, the microwave relay station may further include a control circuit, a phase shifter, a duplexer, and a Butler matrix.

The control circuit may perform processing such as frequency selection, amplification, or frequency conversion on a communication signal. The phase shifter may adjust a phase of a communication signal processed by the control circuit, and send the communication signal to the antenna by using the duplexer and the Butler matrix. The antenna may convert the communication signal into an electromagnetic wave for propagation in space. In addition, the antenna may receive an external electromagnetic wave and feed back the electromagnetic wave to the control circuit, to implement wireless transmission of the signal.

The duplexer is an inter-frequency duplex radio, and a function of the duplexer is to isolate a to-be-emitted signal and a received signal from each other, to ensure that the antenna can simultaneously receive and emit signals normally.

Certainly, during actual application, the microwave relay station may further include another device. This is not described herein again. Alternatively, it may be understood that the antenna provided in embodiments of this application may be used in a currently commonly used microwave relay station. Alternatively, the antenna may be used in another communication device. An application scenario of the antenna is not limited in this application.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. An antenna, comprising:
a primary reflector;
a secondary reflector, disposed opposite to the primary reflector; and
a feed, having a plurality of radiation ports;
wherein the secondary reflector is configured to reflect electromagnetic waves emitted by the plurality of radiation ports to the primary reflector,
the secondary reflector comprises a plurality of curved surfaces, virtual focuses of the plurality of curved surfaces do not coincide, and
the plurality of radiation ports are located in an area formed by a plurality of virtual focuses.

2. The antenna according to claim 1, wherein focal axes of the plurality of curved surfaces coincide.

3. The antenna according to claim 2, wherein the plurality of radiation ports are located in a focal segment formed by the plurality of virtual focuses.

4. The antenna according to claim 2, wherein each curved surface is a curved surface that is rotationally symmetric around the focal axis.

5. The antenna according to claim 2, wherein the plurality of curved surfaces are disposed in sequence from the focal axis to a direction away from the focal axis.

6. The antenna according to claim 4, wherein the plurality of radiation ports are disposed rotationally symmetrically around the focal axis.

7. The antenna according to claim 1, wherein focal axes of at least two curved surfaces are disposed at an included angle.

8. The antenna according to claim 7, wherein real focuses of the plurality of curved surfaces coincide.

9. The antenna according to claim 8, wherein a real focus of the primary reflector coincides with real focuses of the plurality of curved surfaces.

10. The antenna according to claim 1, wherein a quantity of the plurality of radiation ports is the same as a quantity of the plurality of curved surfaces.

11. The antenna according to claim 10, wherein the plurality of radiation ports are respectively located at virtual focuses of the plurality of curved surfaces.

12. The antenna according to claim 2, wherein an included angle between a radiation direction of a radiation port of the plurality of radiation ports and the focal axis is greater than or equal to 0° and less than or equal to 45°.

13. The antenna according to claim 2, wherein a distance between a radiation port of the plurality of radiation ports and the focal axis is greater than or equal to 0 and less than or equal to 5λ, and λ is a wavelength during propagation in space of an electromagnetic wave generated by the radiation port.

14. The antenna according to claim 1, wherein the real focus of the primary reflector is located in an area formed by a plurality of real focuses of the secondary reflector.

15. A communication device, comprising a bracket and an antenna, wherein the antenna, comprising:
a primary reflector, connected to the bracket;
a secondary reflector, disposed opposite to the primary reflector; and
a feed, having a plurality of radiation ports; wherein
the secondary reflector is configured to reflect electromagnetic waves emitted by the plurality of radiation ports to the primary reflector,
the secondary reflector comprises a plurality of curved surfaces, virtual focuses of the plurality of curved surfaces do not coincide, and
the plurality of radiation ports are located in an area formed by a plurality of virtual focuses.

16. The communication device according to claim 15, wherein focal axes of the plurality of curved surfaces coincide.

17. The communication device according to claim 16, wherein the plurality of radiation ports are located in a focal segment formed by the plurality of virtual focuses.

18. The communication device according to claim 15, wherein focal axes of at least two curved surfaces are disposed at an included angle.

19. The communication device according to claim 18, wherein real focuses of the plurality of curved surfaces coincide.

20. The communication device according to claim 15, wherein the real focus of the primary reflector is located in an area formed by a plurality of real focuses of the secondary reflector.
